(19) United States
(12) Patent Application Publication
(10) Pub. No.: US 2003/0135824 A1
(43) Pub. Date: Jul. 17, 2003

(54) System for delayed viewing of selected documents hyperlinked to hypertext documents received at a user interactive receiving display station in a computer controlled communication network

(75) Inventors: Cristi Nesbitt Ullmann, Austin, TX (US); Aaron Keith Reed, Austin, TX (US); Deepa S. Desai, Cedar Park, TX (US)

Correspondence Address: Cynthia S. Byrd, International Business Machines Corporation, Intel. Prop. Law Dept., Internal Zip 4054, 11400 Burnet Road, Austin, TX, 78758, US

(73) Assignee: International Business Machines Corporation, Armonk, NY

(21) Appl. No.: 10/047,095

(22) Filed: Jan. 15, 2002

(51) Int. Cl. G06F 15/00

(52) U.S. Cl. 715/513; 715/514

(57) ABSTRACT

An implementation whereby a user may note a hyperlink in a Web document or E-Mail may be of possible interest and avoid the possible waste of time by just saving the hyperlink, rather than accessing and reviewing the linked document. A user is enabled to designate a plurality of hyperlinks in received Web documents for subsequent viewing; the designated hyperlinks are stored whereby the user may subsequently select the stored hyperlinks to thereby access and display their respective linked documents.

### CROSS-REFERENCE TO RELATED COPENDING PATENT APPLICATIONS

The following patent application is assigned to the assignee of the present invention, is filed concurrently herewith and covers subject matter related to the subject matter of the present invention: A SYSTEM FOR RECORDING WORLD WIDE WEB BROWSING SESSIONS ON A REAL-TIME BASIS AND FOR SUBSEQUENTLY DISPLAYING THE RECORDED SESSIONS AS SURROGATE BROWSING SESSIONS WITH USER ENABLED REAL-TIME MODIFICATION, Cristi N. Ullmann et al., (Attorney Docket No. AUS920010907.US1). This copending application is hereby incorporated by reference.

### TECHNICAL FIELD

The present invention relates to computer managed communication networks such as the World Wide Web (Web) or other Electronic Mail networks and, particularly, to systems, processes and programs for enabling users to optimize their time spent in reading and browsing received hypertext documents and other documents hyperlinked to such received hypertext documents.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or Web related distribution of documents, media and programs. The convergence of the electronic entertainment and consumer industries with data processing exponentially accelerated the demand for wide ranging communication distribution channels, and the Web or Internet, which had quietly existed for over a generation as a loose academic and government data distribution facility, reached “critical mass” and commenced a period of phenomenal expansion. With this expansion, businesses and consumers have direct access to all matter of documents, media and computer programs.

In addition, Hypertext Markup Language (HTML), which had been the documentation language of the Internet or Web for years, offered direct hyperlinks between Web pages embedded in such Web pages. This even further exploded the use of the Internet or Web. Concurrently with and driven by this Internet expansion, the Internet has become a primary facility for mail distribution, i.e., E-Mail. E-Mail is distributed as hypertext documents with hyperlinks that may be selectively activated to access documents linked to the E-Mail document being distributed.

It is now possible for the Web browser or wanderer to spend literally hours going through document after document in often less than productive excursions through the Web. These excursions often strained the users' time and resources. A significant source of this drain is in the Web page itself (the basic document page of the Web). In the case of Web pages, we do not have the situation of a relatively small group of professional designers working out the human factors; rather, in the era of the Web, anyone and everyone can design a Web page or document. As a result, Web pages are frequently setup and designed in an eclectic manner. Often Web pages or documents are set up through loose business, professional, social and educational configurations with general trade or public input of Web pages. The names or identifiers selected for the hyperlinks by Web pages hosts or authors are often very similar to each other. We have found that the user going through Web searches or browses may find it virtually impossible to recognize which identifiers or hyperlinks are documents that are of particular interest to the user. Frequently, a user may waste considerable time accessing and exploring a document linked to the currently displayed Web document only to discover that the information that he is seeking is found in a subsequent Web document or in a subsequently accessed linked document.

A similar problem exists with E-Mail documents. It is so simple to hyperlink a document to an E-Mail document that many senders of E-Mail may indiscriminately attach several documents of questionable pertinence to a piece of E-Mail. Also, many E-Mail documents have such wide distribution that many attachments are of interest to only some of the recipients. It is often the case that the receiver of an E-Mail document may open and access one or more linked documents in the course of his reading only to find that the information that he is seeking is set forth later in the basic E-Mail document, and that he essentially wasted his time in opening the earlier linked documents.

### SUMMARY OF THE PRESENT INVENTION

The present invention offers a solution to this problem by providing an implementation whereby a user may note a hyperlink may be of possible interest and avoid the possible waste of time by just saving the hyperlink, rather than accessing and reviewing the linked document. Accordingly, the present invention provides an implementation based on the combination of means enabling a user to designate a plurality of hyperlinks in received documents for subsequent viewing; means for storing said designated hyperlinks; and means for selecting said stored hyperlinks to thereby access and display their respective linked documents. The network may be the Internet or Web (terms used interchangeably), and the hypertext documents are Web pages. Similarly, the invention is applicable to E-Mail with linked attachments.

In accordance with another aspect of the invention, means are provided for selecting said stored hyperlinks to thereby access and cache their respective linked documents in combination with means enabling the user to selectively display said cached documents. These cached documents are stored so that they may be viewed as needed off-line from the communication network. Most effectively, the stored hyperlinks are temporarily stored so that they may be deleted after their respective linked documents are displayed. The functions of the present invention may be effectively carried out in a Web browser associated with the receiving display station.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of functioning as a user interactive Web station for receiving and transmitting Web pages, as well as E-Mail;

FIG. 2 is a generalized diagrammatic view of a Web portion showing how the Web may be accessed to and from the Web stations through browser applications for the requesting Web pages and for storing selected hyperlinks in received Web documents and for caching the documents linked through such hyperlinks;

FIG. 3 is a diagrammatic view of a Web page displayed through a browser at a receiving display station set up to illustrate the selective hyperlinks store function provided through the present invention;

FIG. 4 is the diagrammatic display view of FIG. 3 illustrating how the user may selectively store hyperlinks in a received Web page for delayed or future viewing on the display;

FIG. 5 is an illustrative flowchart describing the setting up of the process needed in the Web browser for enabling a user to selectively store hyperlinks whereby their respective linked documents may be subsequently displayed as desired by the user;

FIG. 6 is a flowchart of an illustrative run of a routine permitting a user to selectively store hyperlinks from Web documents; and

FIG. 7 is a flowchart of an illustrative run of a routine enabling a user to view and display document links to the hyperlinks selectively stored in the run of FIG. 6, either on-line during a Web browsing session or off-line from the Web session.

### DETAILED DESCRIPTION OF THE PREFERRED EMBODIMENT

The present invention involves the recognition of carrying out the temporary storage of hyperlinks from Web documents to linked documents at the Web browser application associated with a Web receiving display station that gives the user a much wider variety of options in handling hyperlinks from previously accessed Web pages that are of questionable interest to the user. The following embodiments will illustrate some of these advantages.

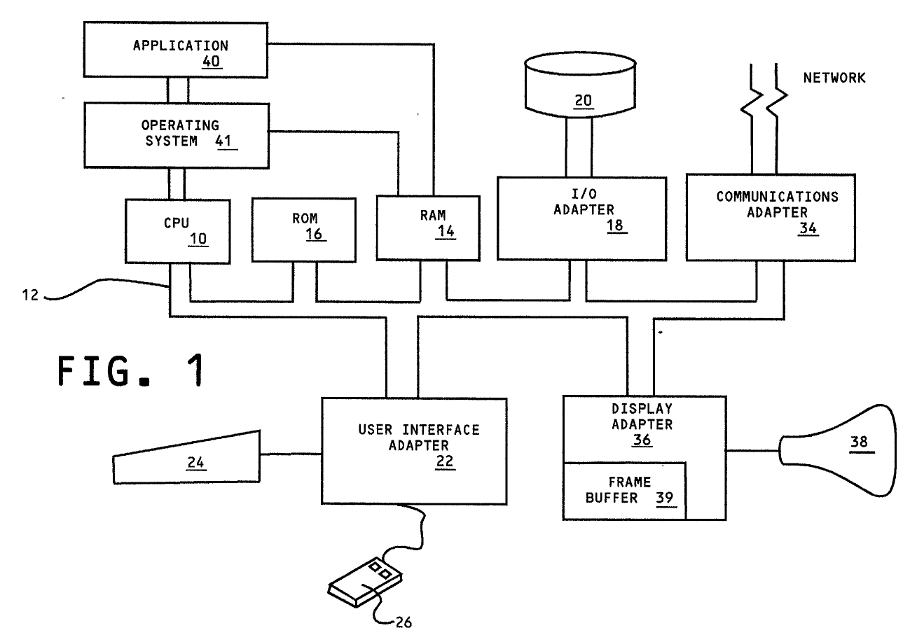

Referring to FIG. 1, a typical data processing terminal is shown which may function as the computer controlled network terminals or Web display stations used for receiving Web pages and for the delayed display of documents linked to hyperlinks in Web documents or E-Mail received at such display stations. A central processing unit (CPU) 10, such as one of the PC microprocessors or workstations, e.g. eServer pSeries available from International Business Machines Corporation (IBM) or Dell PC microprocessors, is provided and interconnected to various other components by system bus 12. An operating system 41 runs on CPU 10, provides control and is used to coordinate the function of the various components of FIG. 1. Operating system 41 may be one of the commercially available operating systems such as IBM's AIX 6000™ or Microsoft's WindowsMe” or Windows 2000™, as well as UNIX and other IBM AIX operating systems. Application programs 40, controlled by the system, are moved into and out of the main memory Random Access Memory (RAM) 14. These programs include the program of the present invention for the delayed viewing of documents linked to received Web pages and E-Mail, which will be described hereinafter in combination with any conventional Web browser at the receiving Web station, such as Netscape 3.0™ or Microsoft's Internet Explorer™. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside Internet or Web network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to the programs for storing selected hyperlinks from received Web documents and E-Mail at the receiving display terminal for subsequent viewing of the respectively linked documents according to the present invention.

Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods that may be related to the present invention. Since a major aspect of the present invention is directed to documents, such as Web pages transmitted over networks, an understanding of networks and their operating principles would be helpful. We will not go into great detail in describing the networks to which the present invention is applicable. Reference has also been made to the applicability of the present invention to a global network such as the Internet or Web. For details on Internet nodes, objects and links, reference is made to the text, Mastering the Internet, G. H. Cady et al., published by Sybex Inc., Alameda, Calif., 1996.

The Internet or Web is a global network of a heterogeneous mix of computer technologies and operating systems. Higher level objects are linked to the lower level objects in the hierarchy through a variety of network server computers. These network servers are the key to network distribution, such as the distribution of Web pages and related documentation. In this connection, the term “documents” is used to describe data transmitted over the Web or other networks and is intended to include Web pages with displayable text, graphics and other images. This displayable information may be still, in motion or animated, e.g. animated GIF images.

Web documents are conventionally implemented in HTML language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly at pp. 637-642, on HTML in the formation of Web pages. The images on the Web pages are implemented in a variety of image or graphic files such as MPEG, JPEG or GIF files, which are described in the text, Internet: The Complete Reference, Millenium Edition, Young et al., 1999, Osborne/McGraw-Hill, particularly at pp. 728-730.

Among the type of documents that may transmitted over the Internet or like networks are E-Mail documents. Like Web pages, E-Mail documents contain links that are selectively activatable to access the linked documents. These E-Mail documents and their hyperlinks may be treated in the same way that Web pages are treated in accordance with the present invention.

In addition, aspects of this invention will involve Web browsers. A general and comprehensive description of browsers may be found in the above-mentioned Mastering the Internet text at pp. 291-313. More detailed browser descriptions may be found in the above-mentioned Internet: The Complete Reference, Millennium Edition text: Chapter 19, pp. 419-454, on the Netscape Navigator; Chapter 20, pp. 455-494, on the Microsoft Internet Explorer; and Chapter 21, pp. 495-512, covering Lynx, Opera and other browsers.

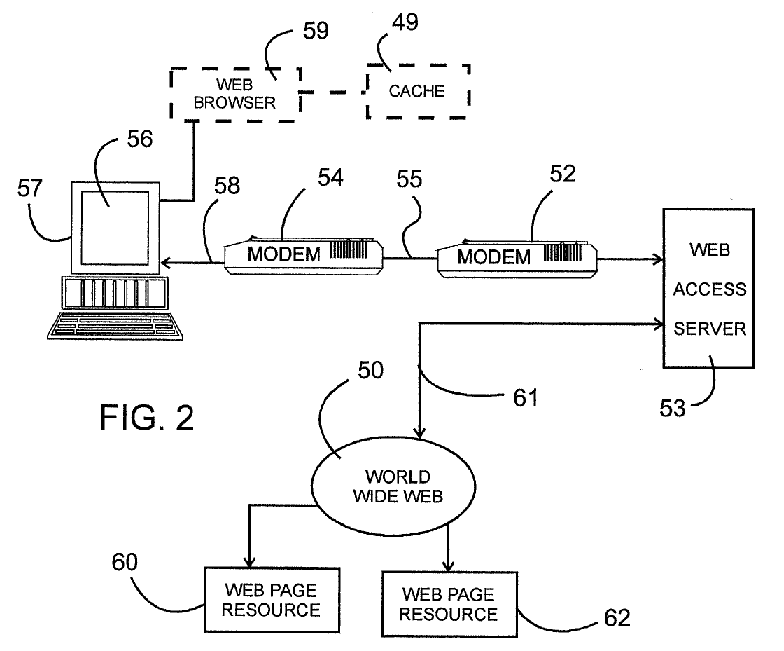

A generalized diagram of a portion of the Web, which the computer controlled display terminal 57 used for Web page receiving during searching or browsing, is connected as shown in FIG. 2. Computer display terminal 57 may be implemented by the computer system setup in FIG. 1 and connection 58 (FIG. 2) is the network connection shown in FIG. 1. For purposes of the present embodiment, computer 57 serves as a Web display station and has received displayed Web page 56, which is one of a sequence of Web pages containing hyperlinks to other Web pages or documents.

Reference may be made to the above-mentioned Mastering the Internet, pp. 136-147, for typical connections between local display stations to the Web via network servers, any of which may be used to implement the system on which this invention is used. The system embodiment of FIG. 2 has a host-dial connection. Such host-dial connections have been in use for over 30 years through network access servers 53 that are linked 61 to the Web 50. The Web servers 53, which also may have the computer structure described with respect to FIG. 1, may be maintained by an Internet Service Provider (ISP) to the client's display terminal 57. The Web server 53 is accessed by the client terminal 57 through a normal dial-up telephone linkage 58 via modem 54, telephone line 55 and modem 52. The HTML file representative of the Web page 56 has been downloaded to display terminal 57 through Web access server 53 via the telephone line linkages from server 53, which may have accessed them from the Web 50 via linkage 61. The Web browser program 59 operates within the display terminals 57 to control the communication with the Web access server 53 to thereby download and display the accessed Web pages 56 on terminal 57. The Web access server 53 uses one of the previously described search engines 51 to access via the Web 50 the desired sequence of Web pages from appropriate Web resources such as databases 60 and 62. Web browser 59 will carry out the functions of permitting the user to selectively store in cache 49, hyperlinks from Web documents or E-Mail so that the linked documents may optionally be reviewed. This review may be done off-line by obtaining selective linked documents off the Web and storing such documents in cache 49 until the user decides to display such documents. This may of course be done after the Web session has been completed, and the user is not connected to the Web.

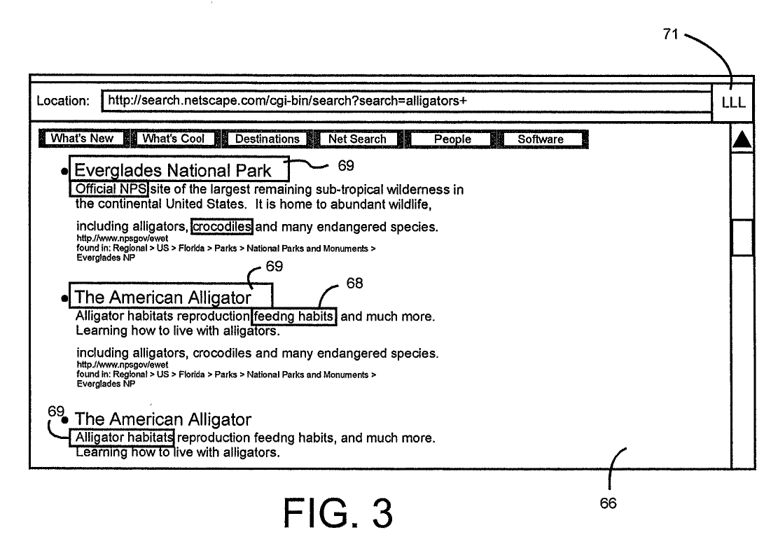

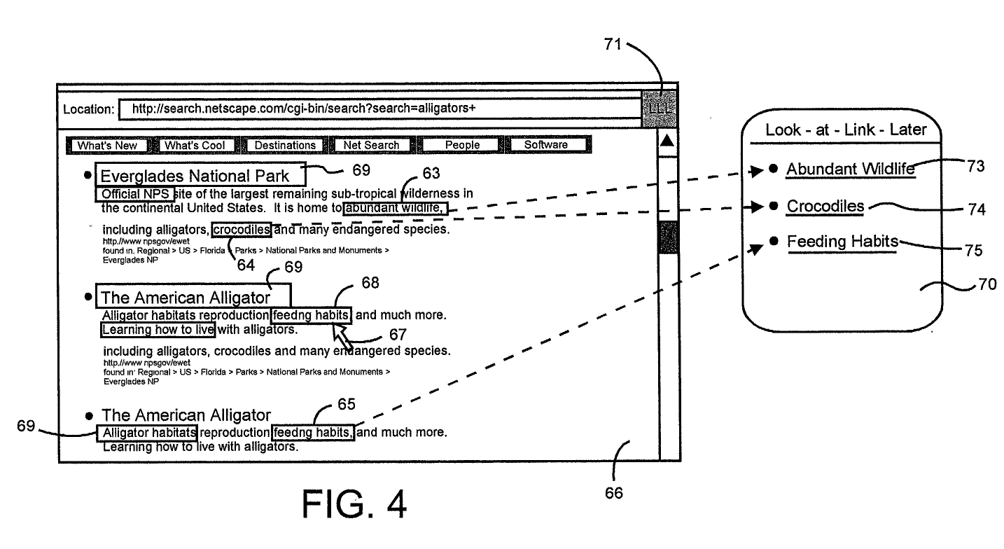

Now, with respect to FIGS. 3 and 4, we will provide an illustrative example of how the present invention may be used for the delayed display of selected documents linked to hyperlinks in Web documents or E-Mail received at Internet receiving display stations. Web page 66, FIG. 3, is an illustration of the displayed Web page 56 in FIG. 2. This standard page contains text, graphics and images, as well as hyperlinks 68 and 69 to other Web documents. Also in the title/menu bar, there is a button “LLL” 71 (Look-at-Link-Later) which the user may click on to put the Web page into the mode shown in FIG. 4 wherein the user is enabled to select hyperlinks for later or delayed viewing of the documents linked to such selected hyperlinks. In this mode, the Look-at-Link-Later folder 70 appears on the display and the user is permitted to grab a hyperlink with his cursor 67 and move that link into LLL folder 70. As shown in FIG. 4, the user has moved hyperlinks 63, 64 and 65 along the dashed line paths shown where such hyperlinks are respectively stored as links 73, 74 and 75. When the next Web page or document subsequently replaces page 66, the user may similarly select hyperlinks in such subsequent documents and move them into LLL folder 70 for optional later viewing of their linked documents. In this manner, a user may put off using time to go into linked documents of questionable value until he has had an opportunity to view a basic group of Web pages that may have resulted from a particular search. Subsequently, after the user has had his opportunity to review his basic search Web pages, he is then enabled to look at any or all of the documents respectively linked to the hyperlinks stored in LLL folder 70.

When a user moves a hyperlink into LLL folder 70 as described above, the URL or Internet address of the linked document is stored. When the user subsequently selects a hyperlink 73-75 from folder 70, the Web browser accesses the linked document from the address and displays the document. Alternately, the Web browser may be programmed to access and store all of the documents linked to the hyperlinks in LLL folder 70. In such a situation, the user may review the accessed and stored documents off-line from the communication network, i.e. after a network session has ended.

Another aspect of this situation may be implemented in the case of E-mail. Most E-mail is not read dynamically over the communication network. It is customarily stored and then read off-line. The documents linked to the E-mail are usually also fetched and stored along with the E-mail. Consequently, when the stored Email is opened and read locally at the receiving station, the user has the option, in accordance with the present invention, of also opening the hyperlinked documents or delaying the reading of hyperlinks by moving such hyperlinks into the LLL folder 70 as described above.

In FIG. 4, for convenience in illustration, LLL folder 70 has been shown separate from the window of window 66. In operation, it is likely that LLL folder 70 would have been superimposed upon or within document 66.

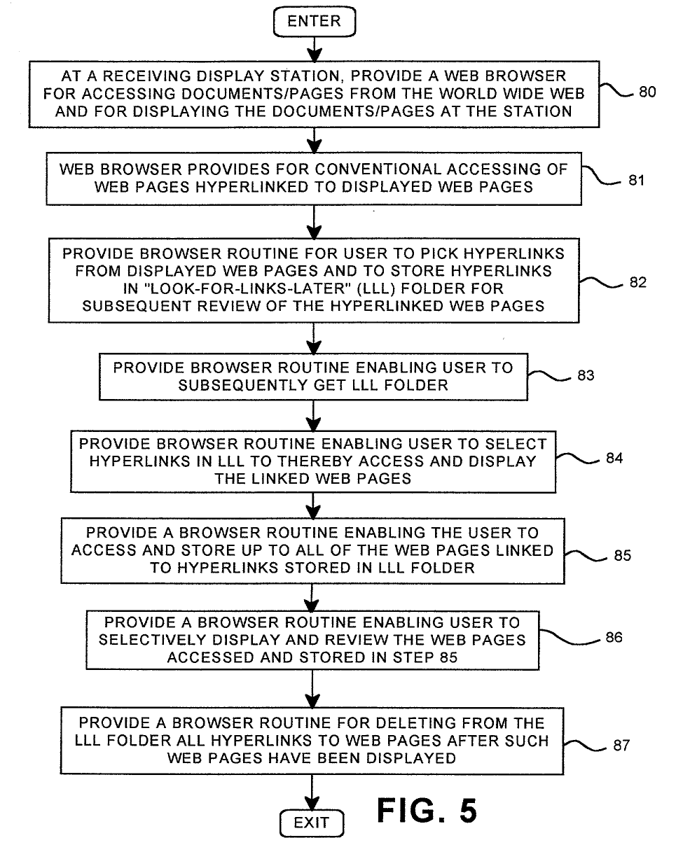

FIG. 5 is a flowchart showing the development of a process according to the present invention for delayed viewing of hyperlinked documents of questionable interest until such time when such interest may be better determined. There is provided at a receiving display station, a web browser for accessing Web pages or documents and for displaying the same, step 80. Web browsers also provide for the accessing of Web pages and other documents hyperlinked to displayed Web pages, step 81. There is provided a browser routine enabling the user to pick hyperlinks from displayed Web pages, and to store the hyperlinks in a LLL folder for subsequent viewing of hyperlinked Web pages and other documents, step 82. The browser is provided with a routine enabling a user to subsequently get the LLL folder, step 83. A routine is provided enabling a user to select hyperlinks in the LLL file to thereby access and display the linked Web pages and other documents, step 84. The browser is further provided with a routine enabling a user to access and store some or all of the Web pages linked to hyperlinks stored in the LLL folder, step 85. There is then provided a browser routine enabling a user to selectively display and review the Web pages accessed and store in step 86. Finally, a routine is provided in the browser for deleting from the LLL folder all hyperlinks to Web pages after such Web pages have been displayed.

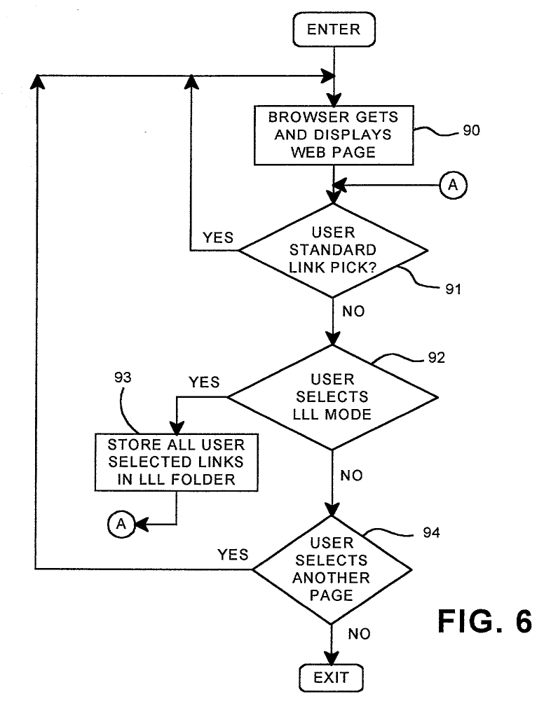

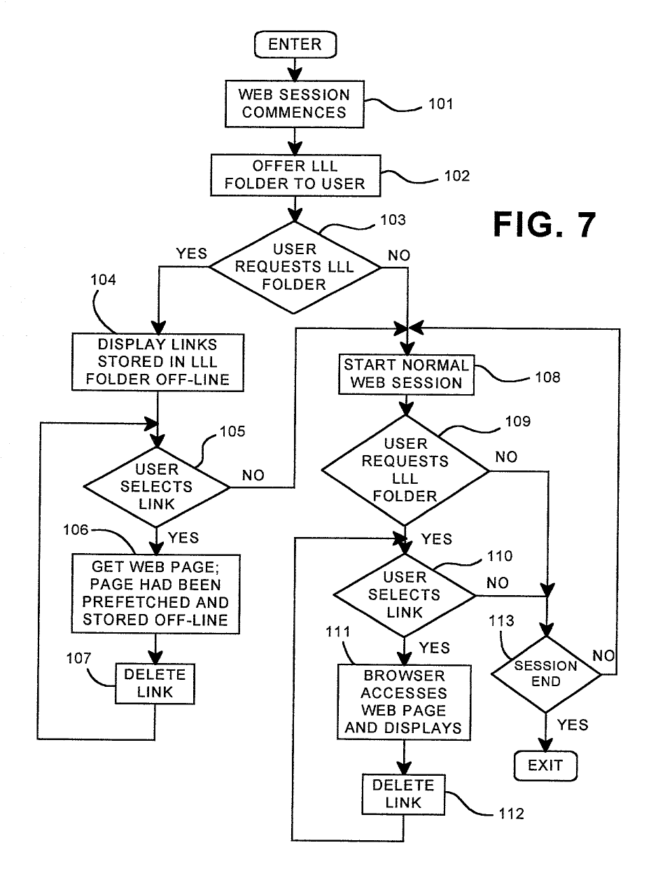

The running of the process set up in FIG. 5 will now be described with respect to the flowchart of FIGS. 6 and 7. Let us assume that we are in a Web browsing session through the browser. The flowchart of FIG. 6 represents some steps in a routine that will illustrate the operation of the invention. The browser, via the ISP Web server, accesses the pages found by a search engine; the next Web page is accessed, step 90. A determination is made, step 91, as to whether the user has selected a hyperlink in the Web page to thereby access and display a Web page. If Yes, the browser returns process to step 90 where it gets and displays the next Web page. If the determination from step 91 is No, a further determination is made, step 92, as to whether the user has selected to operate in the LLL mode. If Yes, all of the hyperlinks in the displayed Web page selected by the user are stored in the LLL folder, step 93, and the process is then returned to step 91 via branch “A” where a determination is again made as to whether the user has selected a hyperlink in the Web page to thereby access and display a linked Web page or other document etc. If the decision from step 92 is No, the user has not selected the LLL mode, then, step 94, a further determination is made as to whether the user has selected another Web page. If Yes, the browser returns to process to step 90 where it gets and displays the next Web page. If the determination from step 94 is No, the session is exited.

Now, with respect to the flowchart of FIG. 7, there will be described how the hyperlinks stored in the LLL folder are processed. After a Web session commences, step 101, the LLL folder may be initially offered to the user, step 102, by immediately displaying the LLL folder and its contents or the user may be enabled, step 103, to request the LLL folder, i.e. through the pressing of button 71, FIG. 4. Then, if the determination through step 103 is Yes, LLL folder is requested, the LLL folder may conveniently be displayed off-line while the Web session is suspended, step 104; and a determination made as to whether the user has selected a hyperlink stored in the LLL folder, step 105. If Yes, then step 106, the Web page that had been previously prefetched as described hereinabove is gotten, displayed and its stored hyperlink deleted from the LLL folder, step 107, after which the process is returned to step 105 where a further determination is made as to whether the user has selected another stored hyperlink. Then, if No, the normal Web session may be commenced, step 108. During a Web session, a determination may be made as to whether the user has requested the LLL folder on-line during the Web session, step 109. If Yes, a determination is made as to whether the user has selected a hyperlink stored in the LLL folder, step 110. If Yes, then step 111, the Web page is gotten, displayed and its stored hyperlink deleted from the LLL folder, step 112, after which the process is returned to step 110 where a further determination is made as to whether the user has selected another stored hyperlink. If No or if the determination from step 109 is No, the user has not requested the LLL folder, then a determination may be conveniently made at this point as to whether the Web session is over, step 113. If Yes, the session is exited. If No, the process is returned to the normal Web session, step 108.

One of the preferred implementations of the present invention is in application program 40, i.e. a browser program made up of programming steps or instructions resident in RAM 14, FIG. 1, of a Web receiving station and/or Web server during various Web operations. Until required by the computer system, the program instructions may be stored in another readable medium, e.g. in disk drive 20 or in a removable memory, such as an optical disk for use in a CD ROM computer input or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Web itself, when required by the user of the present invention.

One skilled in the art should appreciate that the processes controlling the present invention are capable of being distributed in the form of computer readable media of a variety of forms. Although certain preferred embodiments have been shown and described, it will be understood that many changes and modifications may be made therein without departing from the scope and intent of the appended claims.

What is claimed is:

1. In a computer controlled communication network with user access via a plurality of data processor controlled interactive receiving display stations for displaying received hypertext documents of at least one display page containing text, images and a plurality of embedded hyperlinks, each hyperlink being user selectable to access and display a respective linked document, a system at a receiving display station for delayed viewing of designated linked documents comprising:
means enabling a user to designate a plurality of hyperlinks in received documents for subsequent viewing;
means for storing said designated hyperlinks; and
means for selecting said stored hyperlinks to thereby access and display their respective linked documents.

2. The communication network system of claim 1 wherein said network is the World Wide Web (Web), and said hypertext documents are Web pages.

3. The communication network system of claim 1 further including:
means for selecting said stored hyperlinks to thereby access and cache their respective linked documents; and
means enabling the user to selectively display said cached documents.

4. The communication network system of claim 3 wherein said means enabling the user to selectively display said cached documents are off-line from said communication network.

5. The communication network system of claim 1 further including:
means for deleting each of said designated stored hyperlinks when each of their respective linked designated documents is displayed.

6. The communication network system of claim 2 wherein said system at said receiving display station further includes a user interactive Web browser, said browser including:
said means enabling a user to designate a plurality of hyperlinks in received documents for subsequent viewing;
said means for storing said designated hyperlinks; and
said means for selecting said stored hyperlinks to thereby access and display their respective linked documents.

7. The communication network system of claim 6 wherein said interactive Web browser further includes:
means for selecting said stored hyperlinks to thereby access and cache their respective linked documents; and
means enabling the user to selectively display said cached documents.

8. In a computer controlled communication network with user access via a plurality of data processor controlled interactive receiving display stations for displaying received hypertext documents of at least one display page containing text, images and a plurality of embedded hyperlinks, each hyperlink being user selectable to access and display a respective linked document, a method for delayed viewing of designated linked documents at a receiving display station comprising:
enabling a user to designate a plurality of hyperlinks in received documents for subsequent viewing;
storing said designated hyperlinks; and
selecting said stored hyperlinks to thereby access and display their respective linked documents.

9. The communication network method of claim 8 wherein said network is the Web, and said hypertext documents are Web pages.

10. The communication network method of claim 7 further including the steps of:
selecting said stored hyperlinks to thereby access and cache their respective linked documents; and
enabling the user to selectively display said cached documents.

11. The communication network method of claim 10 wherein said step enabling the user to selectively display said cached documents is performed off-line from said communication network.

12. The communication network method of claim 8 further including the steps of:
deleting each of said designated stored hyperlinks when each of their respective linked designated documents is displayed.

13. The communication method of claim 9 further includes a user interactive Web browser method carried out at said receiving display station, said browser method including:
said step of enabling a user to designate a plurality of hyperlinks in received documents for subsequent viewing;
said step of storing said designated hyperlinks; and
said step of selecting said stored hyperlinks to thereby access and display their respective linked documents.

14. The communication network method of claim 13 wherein said interactive Web browser method further includes the steps of:
selecting said stored hyperlinks to thereby access and cache their respective linked documents; and
enabling the user to selectively display said cached documents.

15. A computer program having code recorded on a computer readable medium for delayed viewing of designated linked documents at a receiving display station in a computer controlled communication network with user access via a plurality of data processor controlled interactive receiving display stations for displaying received hypertext documents of at least one display page containing text, images and a plurality of embedded hyperlinks, each hyperlink being user selectable to access and display a respective linked document, said computer program comprising:
means enabling a user to designate a plurality of hyperlinks in received documents for subsequent viewing;
means for storing said designated hyperlinks; and
means for selecting said stored hyperlinks to thereby access and display their respective linked documents.

16. The computer program of claim 15 wherein said network is the Web, and said hypertext documents are Web pages.

17. The computer program of claim 15 further including:
means for selecting said stored hyperlinks to thereby access and cache their respective linked documents; and
means enabling the user to selectively display said cached documents.

18. The computer program of claim 17 wherein said means enabling the user to selectively display said cached documents are off-line from said communication network.

19. The computer program of claim 15 further including:
means for deleting each of said designated stored hyperlinks when each of their respective linked designated documents is displayed.

20. The computer program of claim 16 wherein said program at said receiving display station further includes a user interactive Web browser program including:
said means enabling a user to designate a plurality of hyperlinks in received documents for subsequent viewing;
said means for storing said designated hyperlinks; and
said means for selecting said stored hyperlinks to thereby access and display their respective linked documents.

21. The computer program of claim 20 wherein said interactive Web browser program further includes:
means for selecting said stored hyperlinks to thereby access and cache their respective linked documents; and
means enabling the user to selectively display said cached documents.
